(19) United States
(12) Patent Application Publication
(10) Pub. No.: US 2008/0201076 A1
(43) Pub. Date: Aug. 21, 2008

(54) Witness Based Tracking Systems And Methods

(76) Inventors: Jyh-How Huang, Longmont, CO (US); Shivakant Mishra, Superior, CO (US); Saqib Amijad, Sunnyvale, CA (US)

Correspondence Address: LATHROP & GAGE LC, 4845 PEARL EAST CIRCLE, SUITE 300, BOULDER, CO, 80301, US

(21) Appl. No.: 11/935,288

(22) Filed: Nov. 5, 2007

Related U.S. Application Data
(60) Provisional application No. 60/856,611, filed on Nov. 3, 2006.

(51) Int. Cl. G01C 21/00

(52) U.S. Cl. 701/213

(57) ABSTRACT

Systems and method provide witness based tracking. An encounter with a first mobile sensor module and a second mobile sensor module is determined. At least one witness event of the encounter is recorded, the witness event comprising a mobile ID of at least one of the first and second mobile sensor modules and a time of the encounter. Stored witness events are exchanged between the first and second mobile sensor modules. Stored witness events are transmitted to an access point when the access point is within communication range of at least one of the first and second mobile sensor modules. Received witness events are sent from the access point to a data processing center and stored within a database. The witness events stored within the database are processed to determine a last encounter of one or both of the first and second mobile sensor modules.

### RELATED APPLICATIONS

This application claims priority to U.S. Provisional Ser. No. 60/856,611, filed 3 Nov. 2006 and incorporated herein by reference.

### BACKGROUND

Timely search and rescue of people in emergency situations is an extremely important service. Mostly it has been difficult to provide such a service due to lack of immediate information needed to determine the current location of the affected person. With the emergence of pervasive computing, several systems have been developed over the last few years that make use of small devices such as cell phones, sensors, etc. These systems form a connected network of satellites, GSM base stations, mobile devices; but the network is severely limited, particularly in remote wilderness areas where maintaining a connected network is very difficult.

For example, a GSM transmitter has to be in the range of a base station to transmit. As a result, it cannot operate in most wilderness areas. While a satellite transmitter is the only viable solution in wilderness areas, it is typically expensive and cumbersome. Further, a line of sight is required to transmit to satellite, and that makes it infeasible to stay connected in narrow canyons, large cities with skyscrapers, rain forests, or even when there is a roof or some other obstruction above the transmitter, e.g. in a car. An RF transmitter has a relatively smaller range of transmission. So, while an in-situ sensor is cheap as a single unit, it is expensive to build a large network that can provide connectivity over a large wilderness area. In a mobile environment where sensors are carried by moving people, power-efficient routing is difficult to implement and maintain over a large wilderness area. In fact, building an ad hoc sensor network using only the sensors worn by hikers is nearly impossible due to a relatively small number of sensors spread over a large wilderness area.

### SUMMARY OF THE INVENTION

In an embodiment, a method provide witness based tracking. An encounter with a first mobile sensor module and a second mobile sensor module is determined. At least one witness event of the encounter is recorded, the witness event comprising a mobile ID of at least one of the first and second mobile sensor modules and a time of the encounter. Stored witness events are exchanged between the first and second mobile sensor modules. Stored witness events are transmitted to an access point when the access point is within communication range of at least one of the first and second mobile sensor modules. Received witness events are sent from the access point to a data processing center and stored within a database. The witness events stored within the database are processed to determine a last encounter of one or both of the first and second mobile sensor modules.

In another embodiment, a system provides witness based tracking, including: at least two mobile sensor modules, at least one of the mobile sensor modules attached to an item to be tracked, the mobile sensor modules (a) determining an encounter when within communication range to each other, (b) storing a witness event of the encounter and (c) exchanging previously stored witness events with one another, each witness event comprising the module ID of one mobile sensor module and time of the encounter; at least one access point strategically located to communicate with mobile sensor modules and to receive stored witness events therefrom; and a data processing center for receiving witness events from the at least one access point and for storing the witness events within a database, the data processing center processing the witness events within the database to determine a last known encounter for one or more mobile sensor modules.

### BRIEF DESCRIPTION OF THE FIGURES

FIG. 1 shows one exemplary witness based tracking system with a mobile sensor module, an access point, a location point and a data processing center, in an embodiment.

FIG. 2 shows the mobile sensor module of FIG. 1 in further detail.

FIG. 3 shows a snapshot of two hikers, each carrying one mobile sensor module, one access point, and a GPS satellite.

FIG. 4 shows a later snapshot where the hikers of FIG. 3 encounter one another on a trail.

FIG. 5 shows a later snapshot illustrating one hiker continuing along the trail while the other hiker reaches a trail head where the access point is located.

FIG. 6 shows exemplary data fields of a witness event.

FIG. 7 shows one exemplary handshake protocol that operates between mobile sensor modules to reduce the amount of data transfer.

FIG. 8 shows one exemplary group that includes five mobile sensor modules.

FIG. 9 shows one exemplary group with eight mobile sensor modules that are formed as four partitions.

FIG. 10 shows a group with six mobile sensor modules divided into three partitions, each partition having two peers.

FIG. 11 shows the group of FIG. 10 divided into two partitions, each partition having three peers.

FIG. 12 is a flowchart illustrating one exemplary method for witness based tracking.

### DETAILED DESCRIPTION OF THE FIGURES

Systems and methods herein disclose a mobile sensor module that may be carried, worn or otherwise attached to hikers, skiers, and climbers who participate in activities mainly in remote (e.g., wilderness) areas. The mobile sensor module provides a much higher chance to convey location information of these wearers to a control center. The mobile sensor module is not reliant upon constant connectivity with a communication medium, but passes information to other mobile sensor modules, thereby eventually conveying information to a control center. The mobile sensor module, unlike several of the systems discussed above, allows location information to be used even when the mobile sensor device itself has been damaged and made non-functional by an accident. Since information is relayed to a central processing location, that information is available to search and rescue systems for determining a last know location of a lost person, and possibly a history of their movements.

The mobile sensor module is small an unobtrusive, and provides sufficient functionality (e.g., memory and communication range) to track a large number of modules without requiring a large power source.

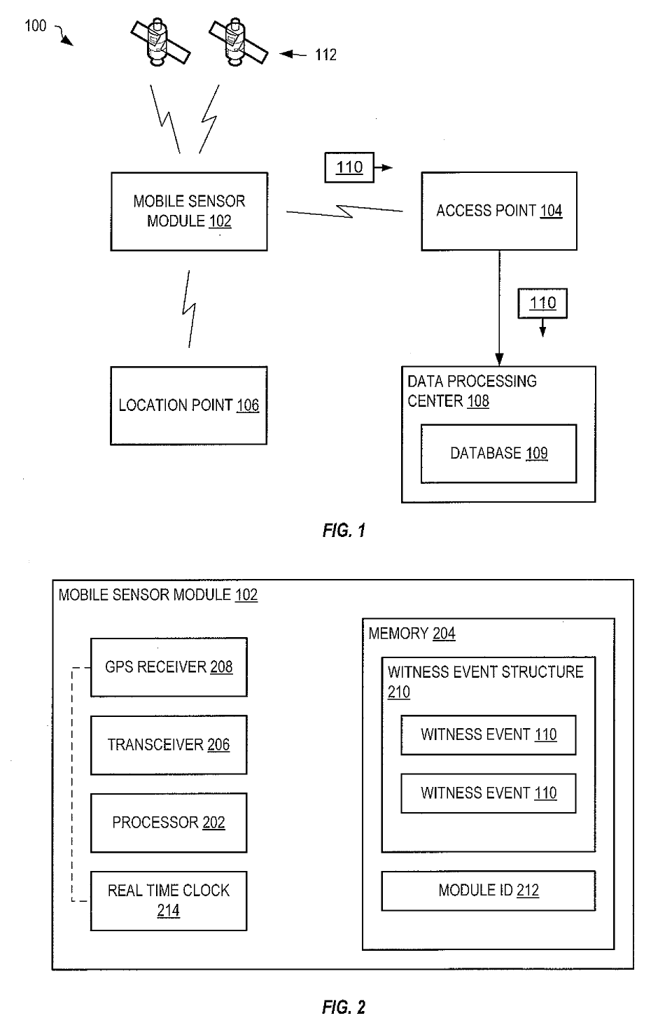

FIG. 1 shows one exemplary witness based tracking system 100 that includes a mobile sensor module 102, an access point 104, a location point 106 and a data processing center 108. Mobile sensor module 102 may be worn by a subject (e.g., a person, an animal, an in-animate object). As shown in FIG. 2, mobile sensor module 102 includes a processor 202, a memory 204, a transceiver 206 and optionally a GPS receiver 208. Mobile sensor module 102 is not necessarily in continuous wireless communication range of access point 104, location point 106 and other mobile sensor modules. However, during operation, mobile sensor module 102 may periodically come into communication range of other mobile sensor modules, one or more location points 106 and one or more access points 104. In particular, system 100 does not require expensive GSM or satellite transceivers to maintain an ad hoc network for communication between mobile sensor modules 102, location point 106 and access point 104. Mobile sensor modules 102 each have a unique ID within system 100. Mobile sensor module 102 periodically (e.g., once a minute) emits a beacon signal that allows it to be detected by other mobile sensor modules, access points 104 and location points 106, that are within wireless communication range. In one example, communication range of each mobile sensor module 102 is approximately 180 feet, line-of-sight and 150 feet non-line-of-sight. Access point 104 and location point 106 may emit a beacon signal at a faster repetition rate (e.g., every 5 seconds) to avoid missing mobile sensor modules 102 passing through its communication range.

When mobile sensor module 102 comes into wireless communication range of location point 106, mobile sensor module 102 stores the current time and location, determined from location point 106, within memory 204 for future reference. Where mobile sensor module 102 includes GPS receiver 208, processor 202 may periodically operate to store a time and last known location information within memory 204. Thus, when location information is not currently available to mobile sensor module 102, a last known location and time may be referenced.

When mobile sensor module 102 comes within communication range of another mobile sensor module, a witness event 110 occurs that is recorded by both mobile sensor modules. Witness event 110 contains information of the encounter, including at least a time of the encounter and an identifier that identifies the encountered mobile sensor module. Memory 204 stores a plurality of witness events 100 within witness event structure 210. Where mobile sensor module 102 includes GPS receiver 208, the encountered mobile sensor module ID, time and location of the encounter is recorded (providing GPS reception is possible) within witness event 110. Where current location information is not available, at least time and encountered mobile sensor module ID is recorded within witness event 110. Furthermore, by exchanging witness events 110 stored within memory 204 of each mobile sensor module 102 as they encounter other mobile sensor modules, these witness events are propagated beyond the encounter between the first two mobile sensors modules.

As mobile sensor module 102 comes into wireless communication range of access point 104, mobile sensor module 102 sends stored witness events 110 to access point (AP) 104, which, in turn, relays (e.g., wirelessly and/or wired) witness events 110 to data processing center 108. Data processing center 108 collects witness events 110 within a database 109 and may operate to track movement of one or more mobiles sensor modules 102 by analysis of received witness events, as discussed in detail below.

Since continuous communication with mobile sensor module 102 is not required, low signal strengths (i.e., short range RF communication) may be used by mobile sensor module 102. Witness events 110 are propagated between mobile sensor modules 102 through an intermittently connected network, thereby allowing system 100 to be deployed in remote areas, as well as in large urban areas with skyscrapers and other structures that may impede communication. Mobile sensor module 102 may be constructed as a light-weight and low-cost sensor; this sensor can include GPS receiver 208 but does not require expensive (in cost and power) GSM or satellite transceivers.

Access point 104 may be located at a well-known location, through which mobile sensor modules 102 are expected to pass. For example, where mobile sensor modules 102 are carried by hikers, access points 104 may be located at one or more of trail heads, trail ends, trail intersection, scenic view points, resting areas, and so on. Thus, as hikers pass through these locations, witness events 110 stored within their mobile sensor modules 102 may be information transferred to the access point which periodically or instantaneously transfers these witness events to data processing center 108 for storage within database 109. Access points 106 may connect to data processing center 108 via one or more of a satellite link, a mobile phone network or some other network (e.g., the Internet). Data processing center 108 may connect to many access points 106, but no connection from one access point to another is needed. Data processing center 108 may then process witness events 110 stored within database 109 to track movement of one or more mobile sensor modules 102. If a hiker wearing a mobile sensor module 102 becomes lost, data processing center 108 may process witness events 110 within database 109 to determine a last known (witnessed) location of the lost hiker.

In the following example, mobile sensor modules 102 are carried by hikers walking trails 320 within a wilderness. FIG. 3 shows a snapshot 300 of two hikers A and B, each carrying one mobile sensor module 102 having an indicated communication range 302(A) and 302(B), respectively, one access point 104 having an indicated communication range 304, and a GPS satellite 112. In snapshot 300, mobile sensor modules 102(A) and 102(B) are not in communication range of each other, and are not in communication range 304 of access point 104. Mobile sensor modules 102(A) and 102(B) maintain, for example within memory 204, current location determined from GPS satellite 112.

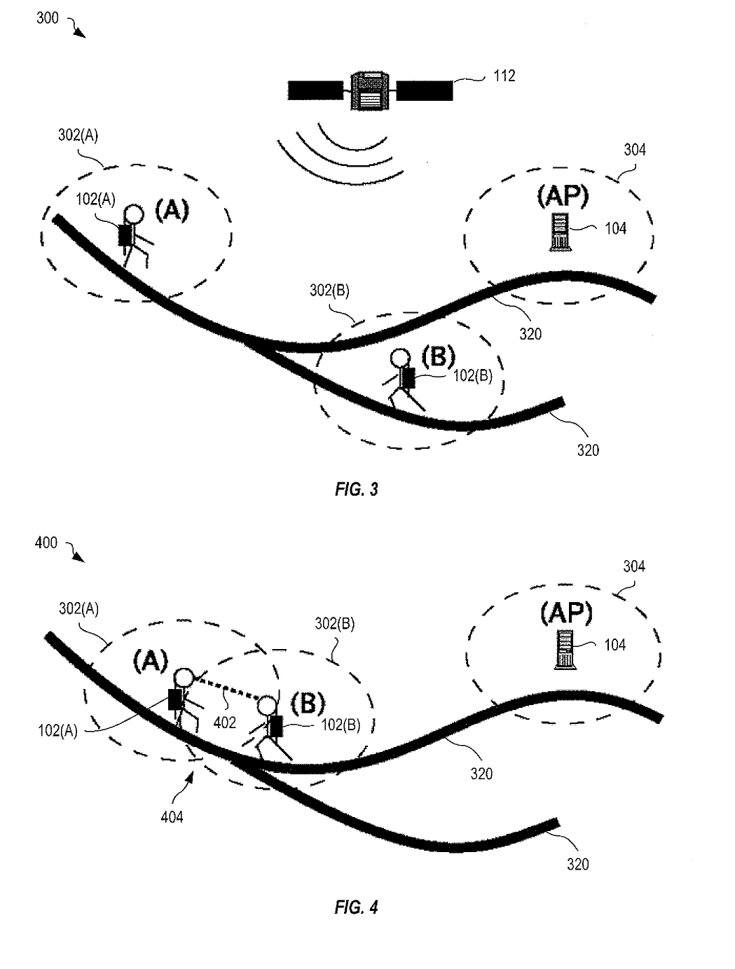

FIG. 4 shows a later snapshot 400 where hikers A and B encounter one another on trail 320 at location 404 such that mobile sensor module 102(A) is within communication range 302(B) of mobile sensor module 102(B), and thus mobile sensor module 102(B) is within communication range 302(A) of mobile sensor module 102(A). Thus, upon one mobile sensor module 102 detecting the beacon signal of the other, communication 402 occurs between the mobile sensor modules, resulting in a witness event 110 to be created within each mobile sensor module 102(A) and 102(B) and sharing of other stored witness events 110.

Mobile sensor module 102(B) emits a beacon signal which is detected by mobile sensor module 102(A). Mobile sensor module 102(A) then sends witness events 110 from its witness event structure 210 stored in memory 204, thereby imparting information such as: “My ID is A; I saw C at 1:23 PM at (39°49.3277655′, 105°39.1126776′), I saw E at 3:09 PM at (40°49.2234879′, 105°20.3290168′)”. Mobile sensor module 102(B) may then respond by sending its stored witness events 110 to mobile sensor module 102(A), thereby imparting information such as: “My ID is B; I saw K at 11:20 AM at (39°51.4531655′, 105°41.6776223′)”. Mobile sensor module 102(A) generates a new witness event 110 for its current encounter with mobile sensor module 102(B), including information such as “I saw B at 4:17 PM at location 404 (e.g., 41°29.3177354′, 105°04.9106211′);” similarly, mobile sensor module 102(B) generates a new witness event 110 for its encounter with mobile sensor module 102(A) including information such as: “I saw A at 4:17 PM at location 404 (i.e., 41°29.3177354′, 105°04.9106211′)”.

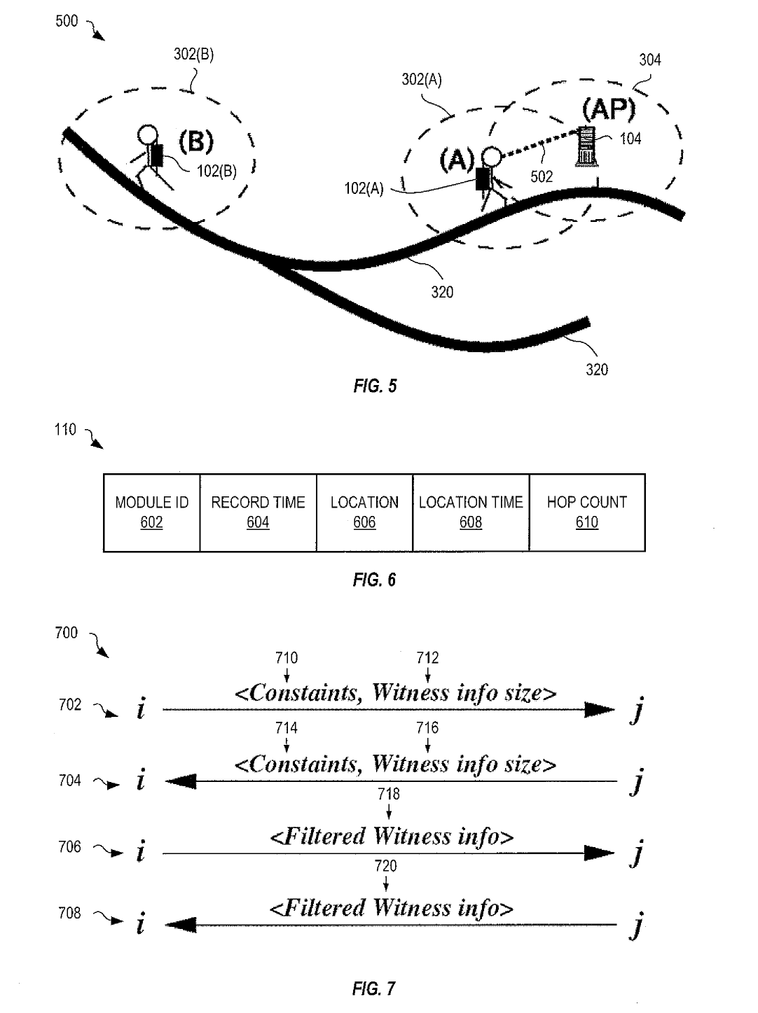

FIG. 5 shows a later snapshot 500 illustrating hiker B continuing along trail 320 (e.g., on his way to overnight camping) while hiker A reaches a trail head where access point 104 is located. Mobile sensor module 102(A) communicates with access point 104, once within communication range, and transfers all witness events stored within memory 204 to the access point, which in turn transfers the witness events 110 to data processing center 108 for storage within database 109.

Given a walking speed of one mile per hour (88 feet per minute) and a communication range for each mobile sensor module 102 of about 150 feet, two hikers have about 150/88=1.7 minutes to discover the presence of each other and exchange respective witness events. Thus, in this scenario, if each mobile sensor module 102 emits a beacon signal every one-and-a-half minutes, discovery is ensured.

### A. Witness Information: Storage

Since there is limited amount of memory available on each mobile sensor module 102 (e.g., a prototype device has 4 KB SDRAM memory, 128 KB flash memory, and 4-512 KB EEPROM), witness events 10 are stored efficiently within memory 204 to maximize memory use.

FIG. 6 shows exemplary data fields of witness event 110. Module ID 602 is the ID assigned to the encountered mobile sensor module 102; record time 604 stores the time the encounter occurred; location 606 stores the location of the encounter (e.g., latitude and longitude); location time 608 stores the time location 606 was determined (since it may not be the same as record time 604 if current location was not available at the time of the encounter); and a hop count 610 that stores the number times (hops) the witness event 110 has been transferred since being created—hop count 610 is set to 0 when witness event 110 is first created as a result of an encounter and incremented when witness event 110 is received from another mobile sensor module.

In an example, where a unique ID is assigned to each mobile sensor module 102 entering a trail or area, one byte is allocated for module ID 602, although this may be increased to two or more bytes if a large number of hikers are expected to be present at the same time. Record time 604 and location time 608 are each three bytes in length to give a one second precision. Eight bytes are allocated to location 606 to give three bytes each for latitude and longitude coordinates resulting in a precision of 0.37 inches. Since such precision is not actually required, fewer bits may be used.

In an embodiment, a unique module ID is assigned to each mobile sensor module 102, for example during manufacture. The user of the mobile sensor module 102 then registers that unique module ID with his name, such that the module ID may be determined and used for tracking purposes if he is reported missing. In another embodiment, a unique module ID is assigned to each mobile sensor modules 102 at a trail head (e.g., by access point 104) where the user of the mobile sensor module 102 register's their name with the assigned module ID thereby allowing the module ID to be determined when only the name of a missing person is reported.

### B. Location Point and Location Inference

Even where mobile sensor module 102 includes GPS receiver 208, there are conditions where this source of location information is not available, such as in canyons and rainy forests. When there is a heavy cloud cover, GPS receivers may experience inaccuracy in the reported location. For areas where GPS reception is expected to be poor or non-existent, location points 106 may be added. Location point 106 sends a signal containing location information to each mobile sensor module 102 when it is within communication range. Although location points 106 may provide additional accuracy in determining encounter locations, they are not essential to operation of system 100, FIG. 1.

In one example of operation, where location information is not available to two mobile sensor modules 102 that encounter, each records the encounter without location information. If, at a later time and location, one of the mobile sensor modules receives location information, for example from a location point 106, it may update location 606 and location time 608 for witness events 110 within witness event structure 210 that have no location stored. Thus, when the mobile sensor module communicates with access point 104, data processing center 108 may still infer location of the encounter by using the time difference between the record time 604 and location time 608 to estimate the distance traveled by the mobile sensor module 102 before encountering location point 106. For example, a circle, centered at location point 104 with a radius based upon estimated distance traveled by mobile sensor module 102, may be defined by data processing center 108 to estimate the encounter location. By overlaying this circle onto a map of the areas, greater probability may be given to the encounter location.

Where mobile sensor module 102 includes GPS receiver 208, current time may be accurately determined from the GPS signal received. Where GPS time is not available, mobile sensor module 102 may maintain a real time clock 214 that may be synchronized with each access point 104 and each location point 106 encountered. The accuracy of current time (e.g., real time clock 214) required by system 100 is for example on the order of a few seconds.

### Memory and Power Management

To conserve power and memory within mobile sensor module 102, a tradeoff between the amount of memory available and the amount of power consumed may be made.

### A. Memory Management

Continuing with the above hiking example, the number of encounters made by a hiker during a day's hike may be relatively large, and the hiker may encounter the same hikers more than once. The number of witness events 110 to be stored by one mobile sensor module 102 may get very large, since it not only stores witness events 110 for encounters it has made, but also receives witness events made but the mobile sensor modules it encounters. To reduce the number of witness events 110 stored within witness event structure 210, each mobile sensor module 102 may periodically delete witness events from memory 204 based upon three memory management criteria: record count (the number of witness events 110 stored within witness event structure 210 with the same module ID 602), hop count 610 of each witness event 110, and record gap (the difference between record time 604 of two witness events 110 having the same module ID 602).

Thus, in an embodiment, each mobile sensor module 102 maintains three integer parameters: MAX RECORD COUNT, MAX HOP COUNT and MIN RECORD GAP. Mobile sensor module 102 stores at most MAX RECORD COUNT witness events 110 of any one module ID 602. That is, only the newest MAX RECORD COUNT witness events 110 are stored for each module ID 602. Further, only witness events 110 with a hop count 610 less than MAX HOP COUNT are stored. The MAX HOP COUNT parameter provides a balance between two conflicting goals. (1) To ensure that a witness event has been propagated to and thus stored at as many mobile sensor modules as possible, thereby having a high probability of being transferred to an access point 104 as quickly as possible; and (2) to ensure that a witness record is stored within as few mobile sensor modules as possible to prevent clogging of memory 204. MAX HOP COUNT is used instead of time-to-live in deciding when to delete a witness event because the probability of a witness event reaching an access point increases as the hop count 610 increases (i.e., when hop count 610 is five for a witness event 110, that witness event has propagated to at least five other module sensor modules). On the other hand, if old records are discarded without considering hop count 610, there is no guarantee that the deleted witness event is present in any other mobile sensor module.

To save space within memory 204, each mobile sensor module 102 may ensure that the time interval between record time 604 of two witness events 110 with the same module ID 602 is at least MIN RECORD GAP. Mobile sensor module 102 stores the most recent witness event 110 for the same module ID 602 where more than one witness event 110 is within the minimum record time defined by MIN RECORD GAP.

As the stored number of witness events 110 approaches the maximum total number of witness events storable within witness event structure 210, mobile sensor module 102 may adjust the values for one or more of MAX RECORD COUNT, MAX HOP COUNT and MIN RECORD GAP to reduce the number of stored witness events. For example, as the number of stored witness events approaches the maximum, mobile sensor module 102 may do one or more of: decrement MAX RECORD COUNT, decrement MAX HOP COUNT, and increment MIN RECORD CAP. Mobile sensor module 102 may also reset MAX RECORD COUNT, MAX HOP COUNT and MIN RECORD GAP to default values after transferring witness events 110 from witness event structure 210 to access point 104.

### B. Power Management

Behavior of mobile sensor module 102 may be determined by its current conditions. For example, where mobile sensor module 102 determines its rate of travel, it may configure the period between transmitting its beacon signal automatically; the faster the mobile sensor module is moving, the shorter the period between beacon signals. When mobile sensor module 102 is not moving (e.g., at night when the hiker is sleeping) mobile sensor module 102 may go into a sleep mode to save energy.

Further, by monitoring available power, mobile sensor module 102 may selectively determine operational parameters such as beacon signal period (i.e., if battery power is low, mobile sensor module 102 may increase the period between beacon signal transmission), switch to sleep mode between encounters to save power, switch to receive mode only (i.e., save power by not operating GPS receiver 208 and by not transmitting the beacon signal). Mobile sensor module 102 may goes to sleep mode if it is extremely low on power.

The bandwidth and energy limitations of mobile sensor module 102 require that the amount of data transferred between mobile sensor modules 102 be reduced to minimum. FIG. 7 shows one exemplary handshake protocol 700 that operates between mobile sensor modules 102 to reduce the amount of data transfer. Protocol 700 ensures that mobile sensor module 102 transmits only witness events 110 that the other mobile sensor module is willing to receive. This protocol is initiated when a first mobile sensor module 102 receives a beacon signal containing a module ID 212 of the sending mobile sensor module 102 and has not exchanged witness events 110 with that mobile sensor module in the last δ time units. Assume that i represents module ID 212 of a first mobile sensor module 102, that j represents module ID 212 of a second mobile sensor module 102, and that i<j. Protocol 700 consists of four phases 702, 704, 706 and 708.

In phase 702, mobile sensor module i sends receive constraints 710 and witness info size 712 (the number of witness events it has in its memory) to mobile sensor module j. In phase 704, upon receiving constraints 710 and witness info size 712 from mobile sensor module i, mobile sensor module j sends receive constraints 714 and witness info size 716 (the number of witness events it has in its memory) to mobile sensor module i. In phase 706, upon receiving constraints 714 and witness info size 716 from mobile sensor module j, mobile sensor module i sends filtered (based on constraints 714) witness info 718 to mobile sensor module j. In phase 708, upon receiving filtered witness info 718 from mobile sensor module i, mobile sensor module j sends filtered (based on constraints 710) witness info 720 to mobile sensor module i.

Receive constraints 710, 714 are a function of memory and power and may comprise three parameters: record count (specifies the maximum number of records the mobile sensor module wishes to receive), hop count (specifies that only witness events 110 with a hop count 610 equal to or less than the specified value are to be sent) and record gap (which is equivalent to MIN RECORD GAP, describe earlier). Note that protocol 700 is beneficial to both mobile sensor module i and mobile sensor module j; that is they both save memory by receiving only as much information as they are willing to accept and conserve energy by sending only as many witness events as needed.

### C. Groups and Partitions

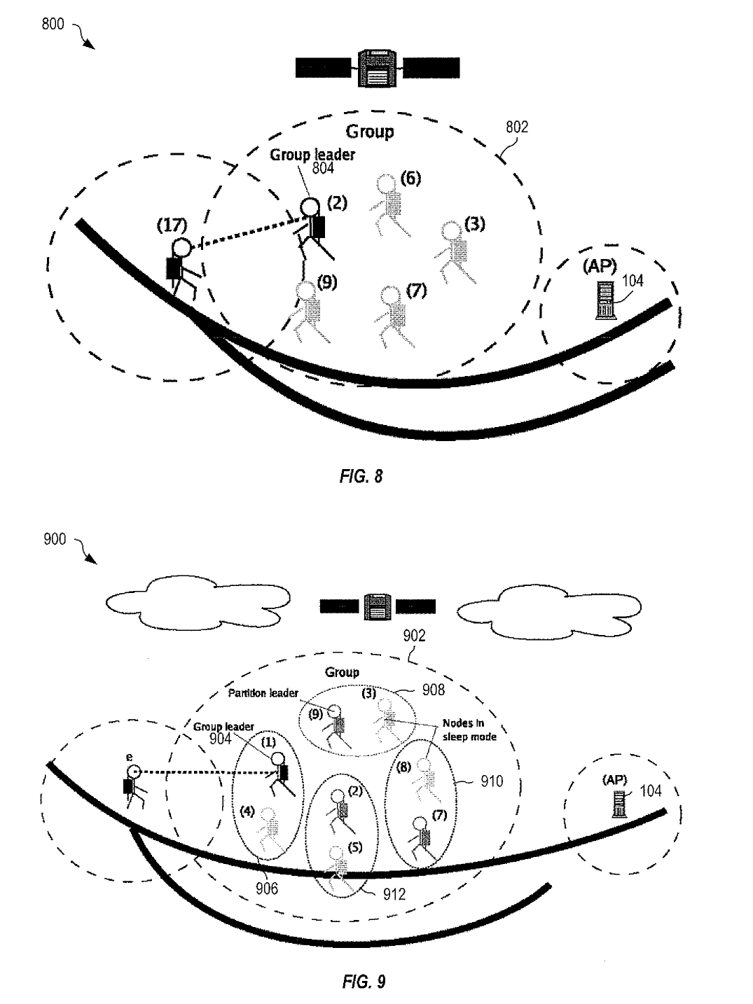

To further reduce the amount of communication and thereby reducing power requirements, mobile sensor modules 102 may be configured as groups and optionally groups with partitions. Groups may be defined based upon one or more of radio connectivity, geographic location, and other properties of mobile sensor modules. FIG. 8 shows a group 802 that includes five mobile sensor modules 102, numbered 2, 3, 6, 7 and 9. Mobile sensor modules 2, 3, 6, 7 and 9 communicate directly with one another and share information to maintain a consistent view of their environment. Group 802 has a group leader 804 (mobile sensor module 2 in this example) that communicates with mobile sensor modules 102 external to, and on behalf of, group 802.

Group 802 may be static, in that group membership does not change over time, or group 802 may be dynamic wherein mobile sensor modules may leave or join group 802. Where group 802 is static, it may be formed prior to use of mobile sensor modules 102 (i.e., static group 802 is formed at the start of a hiking trail or ski slope). Each member of group 802 has a unique module ID 212 and each member of the group is aware of other members. Group 802, as a whole, is also assigned a group ID to distinguish it from other groups of system 100.

During operation, as group 802 travels it exchanges witness events 110 with other mobile sensor modules 102 and groups it encounters. Group leader 804 sends and receives information on behalf of the group and all other n−1 group members (i.e., mobile sensor modules 3, 6, 7 and 9) are in sleep mode, thereby saving energy. Leadership of group 802 is time-multiplexed among the group members to ensure that any one mobile sensor module does not run out of power due to continuous exchange of information. Thus, after every t seconds, leadership passes to another group member, called the successor, and the leader (now an ordinary group member) may switch to sleep mode. The successor is selected based upon module ID 212; the mobile sensor module 102 with the next highest mobile ID in group 802 is chosen as the successor. In the example of FIG. 8, mobile sensor module 3 is successor to group leader 804. The mobile sensor module with the highest module ID selects the mobile sensor module with the lowest mobile ID is as its successor.

Group 802 dynamically manages power and memory usage. Where group members are low on power, the group adopts a scheme that is more energy efficient; whereas, if the group members are approaching memory capacity utilization, the group may adopt a scheme that is more memory efficient.

When group 802 encounters a mobile sensor module 17 that is not a member of group 802, group leader 804 may receive witness events 110 from mobile sensor module 17 and stores those witness events within its memory 204. In a first scheme, when the timeslot for the leader expires (i.e., after t seconds), the leader passes witness events 110 received from mobile sensor module 17 to its successor. Thus the successor (i.e., the new group leader) contains current information for exchanging with other mobile sensor modules external to the group. Thus, as leadership cycles through members of the group, each group member receives the accumulated information.

Although this first scheme is energy efficient and may be a good choice when group members are running low on power, it does not offer memory savings. Since only the group leader is operational in any one timeslot, other groups members are saving power in sleep mode. Thus, for a group of n members, each group member is operation for t seconds every n*t seconds. Thus, the larger the group, the more energy is saved.

In a second scheme, memory space is saved at the cost of energy efficiency. FIG. 9 shows one exemplary group 902 with eight members (mobile sensor modules 1, 2, 3, 4, 5, 7, 8 and 9) that are formed as four partitions 906, 908, 910 and 912. Each partition 906, 908, 910 and 912, is formed of at least two mobile sensor modules 102, referred to hereinafter as peers. Partition 906 includes mobile sensor modules 1 and 4, where mobile sensor module 1 is partition leader. Partition 908 includes mobile sensor modules 3 and 9, where mobile sensor module 9 is partition leader. Partition 910 includes mobile sensor modules 7 and 8, where mobile sensor module 7 is partition leader. Partition 912 includes mobile sensor modules 2 and 5, where mobile sensor module 2 is partition leader. Partition leaders (i.e., mobile sensor modules 1, 2, 7 and 9) operate in receive mode, while other peers switch to sleep mode. Partition leadership is time-multiplexed among peers to make sure that a single node does not run out of power. Group 902 has a group leader 904 which is time-multiplexed among partitions. Group leader 902 also serves as partition leader (i.e., mobile sensor module 1) for partition 906.

In this scheme, partition leaders participate in information exchange when group 902 encounters mobile sensor module “e”; partition leaders receive witness events 110 from mobile sensor module e, but each stores a subset of that information. The subset of information stored within each partition leader is determined by filtering the witness information received from mobile sensor module e such that each partition leader stores only B/K bytes of data, where IC is the number of partitions (four in this example) and B is the total number of bytes received from mobile sensor module e. When group 902 sends witness events 110 to mobile sensor module e, each partition leader sends its stored information (i.e., B/K bytes). That is, each partition leader is coordinated to send their information without collision, for example by group leader 904 sending a signal to each partition leader indicating a time to transmit.

Since partition leadership is time-multiplexed, information received by the partition leader is passed on to the next partition leader. In a first method, prior to the current partition leadership timeslot expiring, the partition leader's successor wakes to receive all stored witness event information from the current partition leader. In a second method, all peers wake prior to the current partition leadership timeslot expiring up to receive witness event information received during the current timeslot as a broadcast from the current partition leader. In both methods, the peers send acknowledgement to the partition leader after receiving the information. In the first method, only one mobile sensor module needs to wake up at the time of partition leadership change, but the amount of information that has to be transmitted between the mobile sensor modules may increase as time passes. In the second method, all peers wake at the time of partition leadership change, but only newly stored information is transmitted each time. Since communication is much more expensive than bringing the nodes up, the second method is preferred.

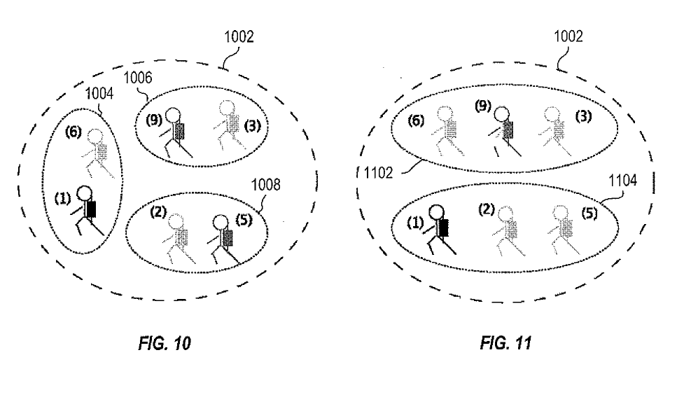

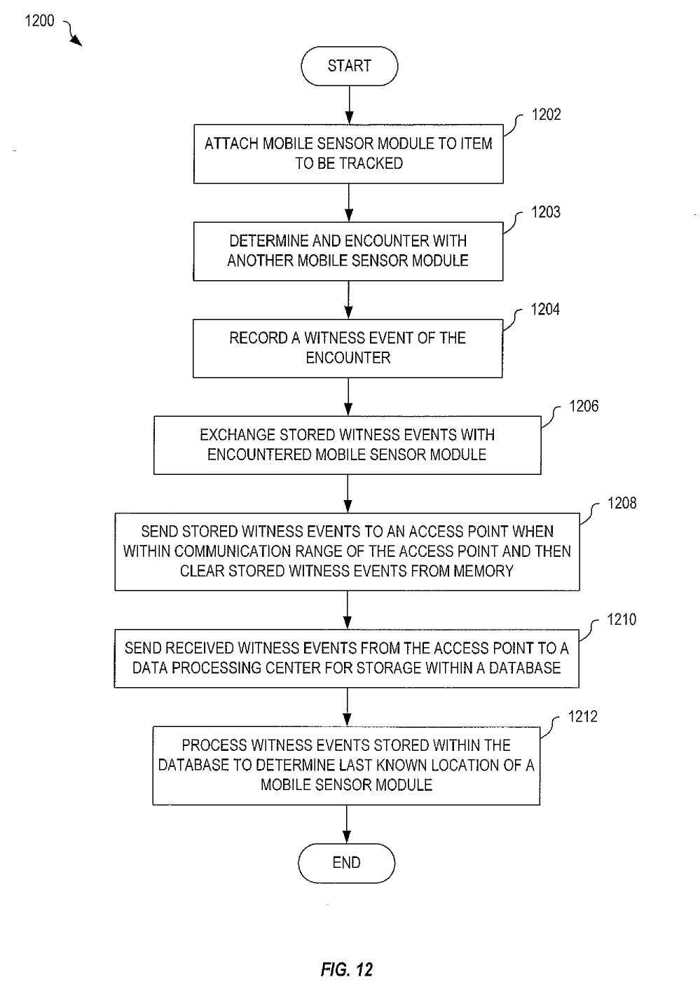

A group may be divided into partitions in more than one way. As shown in FIG. 10, group 1002 has six mobile sensor modules 1, 2, 3, 5, 6 and 9 and is divided into three partitions 1004, 1006 and 1008, each with two peers. FIG. 11 shows group 1002 divided into two partitions 1102 and 1104, each with three peers. Partitions 1102 and 1104 make group 1002 more energy efficient because a greater number of mobile sensor modules are in sleep mode at any given moment. On the other hand, partitions 1004, 1006 and 1008 make memory utilization more efficient since each mobile sensor module stores less information.

Mobile sensor modules 102 that form partitions within a group may modify these partitions dynamically as mobile sensor modules join and leave the group and when mobile sensor modules run out of power. The dynamic partitioning allows the group to maintain at least two peers per partition when mobile sensor modules leave the group.

If mobile sensor module 2 off partition 1008, FIG. 10, stops functioning (e.g., runs out of power), when mobile sensor module 5, the partition leader, sends information to mobile sensor module 2, it does not receive an acknowledgement and therefore concludes that mobile sensor module 2 has failed. (The partition leader may query the non-responsive mobile sensor module a few times before determining it to have failed.) Mobile sensor module 5 then contacts other partition leaders (i.e., mobile sensor modules 1 and 9) using a broadcast message to inform them that one of its peers has failed. Each partition leader then inform node 5 of (i) the number of peers in its partition, (ii) a candidate mobile sensor module that node 5 may take if the number of peers in its partition is greater than 2, and (iii) the amount of witness event 110 information stored in its partition. Upon hearing from each partition leader, mobile sensor module 5 selects the candidate node from the partition with greatest number of peers greater than 2, and sends a message back to other partition leaders. Mobile sensor module 5 then sends data to its new peer to make sure that the information is replicated within the partition.

If each other partition has exactly two peers, then mobile sensor module 5 joins the partition that has the least amount of witness event information to join. It sends its witness event information to the new partition leader. Witness event information and membership update is propagated to all peers during the next partition leadership change.

If a partition leader fails, the new partition leader determines that the previous partition leader has failed when partition leadership changes. Once the new partition leader finds out that it needs more peers, it proceeds with the protocol explained above. However, in this case, witness event information that the previous partition leader might have received while partition leader is lost. Although this problem may be solved by implementing a more rigorous protocol, the energy cost to implement the more rigorous protocol is saved in favor of the information lost.

Time-division multiplexing may be used to schedule wakeup and sleep modes in the mobile sensor modules; however, radio wakeup technology may be used to implement this scheduling more efficiently.

### System Evaluation

A mobile sensor module is constrained by the amount of available memory and available power. The amount of memory needed by, and power consumption of, a mobile sensor module 102 depends upon a variety of factors such as mobile sensor module 102 density, number of encounters, and the number of access points 104.

First, assume that each mobile sensor module 102 stores about one hundred witness events 110. On encountering another mobile sensor module, each mobile sensor module 102 transmits 50 witness events 110 and receives 50 new witness events 110. Since, assuming each witness event 110 is 16 bytes long, it takes 0.34 seconds to transmit 50 witness events and another 0.34 seconds to receive 50 witness events over a 19,200 bits per second (bps) wireless link. The power requirements of an exemplary MICA2 prototype device for CPU processing, transmission and reception are approximately 8.0 mA, 7.0 mA and 8.5 mA, respectively, and the capacity of an alkaline battery is 2500 mAh. Since the radio module of the Mica2 prototype is half-duplex and assuming that the CPU is always active when a mobile sensor module is awake, power consumption due to transmission is 8+8:5=16.5 mA and power consumption due to reception is 8+7=15 mA. So, average power consumption due to transmission and reception is (16:5+15)/2=15.75 mA.

Given that the capacity of an alkaline battery is 2500 mAh, the battery should last for 2500/15.75=159 hours of transmission and reception. An encounter between two hikers results in exchange of about 50 witness events 110 that takes about 0.68 seconds as calculated above. Thus, a single alkaline battery lasts for (159*60*60)/0.68=841,764 hiker encounters.

Assuming that each mobile sensor module 10 emits a beacon signal once every ninety seconds and an encounter occurs each time the beacon signal is emitted (worst-case scenario), mobile sensor modules 102 operate for (841764*90)/(30*24*60*60)=29 days on the alkaline battery.

By including two such batteries, a mobile sensor module 102 may remain operational for about two months, assuming that the mobile sensor module is continuously active (i.e., twenty-four hours a day) and that an encounter with another mobile sensor module occurs each ninety seconds. In a more realistic scenario, power is expected to last for a longer period, for example when groups are used to save power, and operational periods average eight hours, or less, per day.

Further, the operational lifetime of each mobile sensor module 102 using two alkaline batteries may be increased by using additional energy scavenging techniques and energy harvesting techniques known in the art.

### Applications

As described in the above examples, mobile sensor modules 102 may be used by hikers to provide valuable information to search and rescue operations when a hiker goes missing. These mobile sensor modules may also be used for other application such as skiing, climbing, wild life monitoring, and person tracking. Using intermittent connectivity, each mobile sensor module 102 uses mature technologies to implement tracking. Since mobile sensor module 102 does not track its user continuously, relying instead on maintaining witness events for encounters between mobile sensor modules, system 100 is relatively cheap and may be applied widely.

In one exemplary use, a plurality of mobile sensor modules 102 are deployed along a ski resort boundary, for example where dangerous drop-offs occur. Each skier carries a mobile sensor module 102 and if the skier passes the boundary, the mobile sensor module located at the boundary records the encounter. These boundary mobile sensor modules emit beacon signals quite frequently, e.g. every second, and therefore record presence of skiers crossing the boundary. Ski patrols may then cruise the boundaries periodically and automatically query each boundary mobile sensor module when in range. For example, ski patrol personnel may carry a modified mobile sensor module that provides a visual indication to identify a mobile sensor module (i.e., skier) that has been close to the boundary mobile sensor module. Upon verifying activity of the identified mobile sensor module through use of data processing center 108 (i.e., by calling over a two way radio) the ski patrol may, if there is no witness events for the identified mobile sensor module after the recorded time in the boundary mobile sensor module, determine that there is a high chance that a rescue is needed.

In wildlife monitoring, a very popular tracking method utilizes a GPS receiver attached to an animal. To collect data, either a satellite transmitter is used to relay recorded tracking information to a ground station, or the GPS receiver must be collected from the animal to retrieve data stored on the device itself GPS receivers with satellite transmitters are expensive (e.g., a tracing device used to track geese costs about $3,000 each). Such a GPS receiver and satellite transmitter is bulky and uncomfortable for the animal, possibly resulting in abnormal behavior of the animal when it tries to get rid of the GPS receiver and satellite transmitter. Using mobile sensor module 102, the presence of wildlife at a specific location may be recorded as can the activity of the animal away from the monitored location. By locating access points 104 at areas visited by the animals, data is easily retrieved. In fact, access points 104 need not be statically located; they may be placed in a low-altitude plane (e.g., a UAV) and be flown over a wilderness area to collect data from wildlife.

In large cities, mobile sensor modules 102 may be used to complement GPS receiver, since GPS reception does not work in indoor and where line of sight receptions from satellites is not possible (e.g., near skyscrapers). If a person A is reported missing, and witness events for A indicate that his last contacts were C and D, an approximate location may be quickly and efficiently determined.

FIG. 12 is a flowchart illustrating one exemplary method for witness based tracking. Steps 1204-1208 are implemented within mobile sensor module 102, FIG. 1 (particularly under control of processor 202), step 1210 is implemented within access point 104, and step 1212 is implemented within data processing center 108.

In step 1202, method 1200 attaches a mobile sensor module to an item to be tracked. In one example of step 1202, mobile sensor module 102 is attached to a hiker prior to the hiker embarking on a hike through a wilderness. In step 1203, method 1200 determines an encounter with another mobile sensor module. In one example of step 1203, each mobile sensor module 102 periodically transmits a beacon signal and response to a received beacon signal from another mobile sensor module 102 as an encounter. In step 1204, method 1200 records a witness event when another mobile sensor module is encountered. In one example of step 1204, when a first mobile sensor module 102 encounters a second mobile sensor module 102, each stores a witness event 110 defining the ID of the encountered mobile sensor module and the time and location of the encounter. In step 1206, method 1200 exchanges stored witness events with the encountered mobile sensor module. In one example of step 1206, the first mobile sensor module 102 sends witness events 110 stored within memory 204 to the second mobile sensor module 102, and the second mobile sensor module 102 sends its witness events 110 stored within its memory 204 to the first mobile sensor module 102. In step 1208, method 1200 sends stored witness events to an access point when in communication range of the access point and then clears stored witness events from its memory. In one example of step 1208, mobile sensor module 102 comes within communication range of access point 104 and sends witness events 110 from witness event structure 210 of memory 204 to access point 104 and then clears witness event structure 210. In step 1210, method 1200 sends the received witness events from the access point to a data processing center for storage within a database. In one example of step 1210, access point 104 sends received (from mobile sensor 102) witness events 110 to data processing center 108 where they are stored within database 109. In step 1212, method 1200 processes witness events stored within the database to determine a last know location of a mobile sensor. In one example of step 1212, data processing center 108 processes witness events 110 stored within database 109 to determine a last known encounter location for a mobile sensor module 102.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for witness based tracking, comprising:
determining an encounter with a first mobile sensor module and a second mobile sensor module;
recording at least one witness event of the encounter, the witness event comprising a mobile ID of at least one of the first and second mobile sensor modules and a time of the encounter;
exchanging stored witness events between the first and second mobile sensor modules;
transmitting stored witness events to an access point when the access point is within communication range of at least one of the first and second mobile sensor modules;
sending received witness events from the access point to a data processing center and storing the witness events within a database; and
processing the witness events stored within the database to determine a last encounter of one or both of the first and second mobile sensor modules.

2. The method of claim 1, the mobile sensor module being attached to an item to be tracked or to a person engaged in activity.

3. The method of claim 1, the step of transmitting further comprising clearing the stored witness events.

4. The method of claim 1, the step of determining comprising periodically transmitting a beacon signal from the first mobile sensor module and responding to a detected beacon signal from the second mobile sensor module.

5. The method of claim 1, the step of recording further comprising determining a location from a GPS receiver within the first or second mobile sensor module and storing the determined location within the witness event.

6. The method of claim 1, the step of recording further comprising determining a location from a location point and storing the determined location within the witness event.

7. The method of claim 1, further comprising reducing communication between the first and second mobile sensor modules by exchanging constraints and filtering exchanged witness events.

8. The method of claim 7, further comprising discarding witness events based upon memory management criteria.

9. The method of claim 8, the memory management criteria being based upon one or more of memory utilization and power availability.

10. The method of claim 1, the step of processing further comprising processing the witness events within the database to determine two or more last encounters of the first or second mobile sensor module to infer a search area for the first or second mobile sensor module.

11. A system for witness based tracking, comprising:
at least two mobile sensor modules, at least one of the mobile sensor modules attached to an item to be tracked, the mobile sensor modules (a) determining an encounter when within communication range to each other, (b) storing a witness event of the encounter and (c) exchanging previously stored witness events with one another, each witness event comprising the module ID of one mobile sensor module and time of the encounter;
at least one access point strategically located to communicate with mobile sensor modules and to receive stored witness events therefrom; and
a data processing center for receiving witness events from the at least one access point and for storing the witness events within a database, the data processing center processing the witness events within the database to determine a last known encounter for one or more mobile sensor modules.

12. The system of claim 11, further comprising one or more location points for communicating with mobile sensor modules when in communication range to inform the mobile sensor modules of the location of the location point.

13. The system of claim 11, further comprising a GPS receiver within at least one mobile sensor module for determining the location of the encounter, the location being stored within the witness event of the encounter.

14. The system of claim 11, wherein the data processing center determines a search area based upon a last known encounter.

15. The system of claim 11, wherein the data processing center determines previous encounters of at least one mobile sensor module and infers a search area based upon the last known encounter and the previous encounters.
